(19) United States
(12) Patent Application Publication
(10) Pub. No.: US 2015/0327965 A1
(43) Pub. Date: Nov. 19, 2015

(54) SONIC ELECTRIC TOOTHBRUSH

(71) Applicant: WATER PIK, INC., Fort Collins, CO (US)

(72) Inventor: Jeffrey Garrigues, Firestone, CO (US)

(21) Appl. No.: 14/713,898

(22) Filed: May 15, 2015

Related U.S. Application Data
(60) Provisional application No. 61/994,783, filed on May 16, 2014.

(51) Int. Cl. A61C 17/34; F16H 19/08

(52) U.S. Cl. CPC A61C 17/3445; F16H 19/08

(57) ABSTRACT

The present disclosure relates to a sonic oscillating toothbrush. The toothbrush includes a brush head including a plurality of bristles, a motor having a drive shaft, a linkage assembly connected to the drive shaft, and an output shaft connected to the linkage assembly and the brush head. The linkage assembly coverts a rotating movement of the drive shaft into an oscillating movement and the output shaft transmits the oscillating movement to the plurality of bristles.

### CROSS REFERENCE TO RELATED APPLICATIONS

This application claims priority to U.S. provisional application No. 61/994,783 entitled “Sonic Electric Toothbrush,” filed May 16, 2014 and incorporated herein in its entirety. This application is related to U.S. patent application Ser. No. 13/833,897 filed Mar. 15, 2013 and entitled “Electronic Toothbrush with Vibration Dampening,” which is incorporated by reference herein in its entirety.

### TECHNICAL FIELD

The technology described herein relates generally to toothbrushes and more particularly to electronically driven toothbrushes.

### BACKGROUND

Electrically driven toothbrushes typically include a brush head having a plurality of bristles, where the brush head or the bristles are vibrated or rotated by a motor. The rotation and/or vibration of the brush head and/or bristles assists a user is cleaning his or her teeth and gums. Often the rotation of a drive shaft of the motor, as well as other components in the electronic toothbrush, may cause other components of the toothbrush, such as the handle, to vibrate or rotate as well. The vibration in the handle may be unpleasant to a user, as well as make it more difficult for a user to grip the handle and direct the motion of the toothbrush.

The information included in this Background section of the specification, including any references cited herein and any description or discussion thereof, is included for technical reference purposes only and is not to be regarded subject matter by which the scope of the invention is defined in the claims is to be bound.

### SUMMARY

Some embodiments of the present disclosure include a toothbrush including a brush head with a plurality of bristles, a motor having a drive shaft, a linkage assembly connected to the drive shaft, and an output shaft connected to the linkage assembly and the brush head. During operation, the linkage assembly converts a rotating movement of the drive shaft into an oscillating movement and the output shaft transmits the oscillating movement to the plural of bristles.

In some examples the linkage assembly of the toothbrush may include a cam follower connected to the drive shaft. The cam follower may define a gear compartment and a plurality of follower gear teeth extending into the gear compartment. The linkage may also include a planet gear connected to the output shaft, the planet gear including a plurality of planet gear teeth connected to a terminal end of the output shaft and received within the gear compartment. In some instances a ratio of the follower gear teeth to the planet gear teeth determines a speed of the bristles.

The toothbrush may also include a bumper assembly having a first bumper and a second bumper, where the first bumper and the second bumper substantially surrounds a portion of the output shaft.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

### BRIEF DESCRIPTION OF THE DRAWINGS

FIG. 1A is a front isometric view of an electrically driven toothbrush.

FIG. 1B is a side elevation view of the toothbrush of FIG. 1A.

FIG. 1C is a rear perspective view of the toothbrush of FIG. 1A.

FIG. 1D is a bottom plan view of the toothbrush of FIG. 1A.

FIG. 1E is a top isometric view of the toothbrush of FIG. 1A.

FIG. 2 is an isometric view of another example of an electrically driven toothbrush.

FIG. 3 is an isometric view of the toothbrush of FIG. 2 with the housing removed for clarity.

FIG. 4 is an isometric view of the toothbrush of FIG. 2 with the housing and other components removed for clarity.

FIG. 5 is an isometric view of the toothbrush of FIG. 2 illustrating the drive assembly and linkage assembly.

FIG. 6 is an enlarged view of the toothbrush of FIG. 5 with select elements removed for clarity.

FIG. 7 is an isometric view of the toothbrush of FIG. 2 with select elements removed or shown transparent for clarity.

FIGS. 8A-8E illustrate various views of a cam follower of the toothbrush of FIGS. 1A and 2.

FIG. 9 is an isometric view of the toothbrush of FIG. 2 with select elements removed for clarity.

FIG. 10 is a cross-section view of the toothbrush of FIG. 2 taken along line 10-10 in FIG. 9.

FIG. 11 is a front elevation view of a boot seal of the toothbrush of FIGS. 1A and 2.

FIG. 12A is a front elevation view of a chassis for the toothbrush of FIGS. 1A and 2.

FIGS. 12B and 12C and front and rear elevation views, respectively, of a chassis cover for the toothbrush of FIGS. 1A and 2.

FIG. 13 is an enlarged view of a control circuit and motor for the toothbrush of FIGS. 1A and 2.

### DETAILED DESCRIPTION

Various examples of an electronically powered toothbrush are disclosed herein. The toothbrush may include a body, a brush head including a plurality of bristles, a drive assembly, a power assembly to provide power to the drive assembly, a linkage or transmission assembly interconnected between the brush head and the drive assembly, and a plurality of vibration and sound dampening components. Generally, in operation, the power assembly provides power to the drive assembly, the drive assembly rotates and/or vibrates the brush head, the transmission converts the rotation of the drive assembly into an oscillating movement of the bristles, and the vibration and sound dampening components reduce vibration from being transmitted from the motor to the body of the toothbrush, as well as may help to reduce current consumption of the power assembly.

The linkage includes an eccentric connected to the motor shaft. In some embodiments, the eccentric may be attached to a ball bearing and the eccentric may include a counterweight formed therewith to balance the weight of the ball bearing. In these embodiments, the bearing and the counterweight assist in reducing current consumption by reducing friction in the connection between the linkage assembly and the motor drive shaft. They may also reduce noise at the connection joint. In other words, the balanced eccentric including the ball bearing may result in a joint having a reduce amount of friction, which along with the balancing between the bearing and the counterweight, acts to reduce noise as the drive shaft is rotated.

The linkage may include a planetary gear arrangement. For example, the linkage may further include a planet gear connected to a brush head shaft, a cam follower connected to and received around the planet gear, and a clevis connected to the cam follower. The eccentric and bearing of the linkage are connected to the cam follower and cause the cam follower to move therewith. A pivot pin secures the cam follower to the clevis and defines a pivot point about which the cam follower oscillates. The cam follower includes a ring gear defined on an interior surface that meshes with the teeth of the planet gear. As the cam follower pivots, the motion of the cam follower is transmitted to the brush head shaft by the planet gear which, due to the linkage structure, converts the brush head to an oscillating motion. In some embodiments, the ring gear structure of the cam follower includes a first set of gear teeth and the planet gear includes a second set of gear teeth, with the gear ratio between the planet gear and the ring gear set in an overdrive configuration to produce an oscillation speed of the planet gear that is larger than the ring gear of the cam follower. For example, the overdrive configuration causes the output or brush head shaft connected to the planet gear to oscillate at a higher frequency than would be produced if the output shaft was directly connected to the drive shaft.

Additionally, the output shaft may include one or more ball bearings attached thereto. The ball bearings may further include a compressible component, such as an O-ring received around their outer surface. The ball bearings along with O-rings as dampeners may reduce noise from the drive assembly. For example, the dampeners may prevent the bearings from rattling in instances where the fit between the bearing and the output shaft is loose or has some slop. Additionally, the dampeners may exert a uniform load on the bearings, which may prevent the bearings from being compressed (due to rotational forces) into a non-uniform shape, such as an oblong shape. Further, by reducing rattling noise, as well as preventing the bearings from being formed into non-uniform shapes, noise generated by the drive assembly may be reduced. This is because the rattling, as well as oblong or other non-uniform bearing shapes, may increase audible noise produced by the toothbrush.

The toothbrush may further include one or more bumpers attached to an output shaft. For example, the output shaft may include a dowel pin that interacts with two rubber bumpers connected to each other around the output drive shaft. The bumpers absorb kinetic energy from the angular velocity of the output shaft transmitted through the dowel pin and may then reapply the energy to reverse the direction of rotation. By reapplying absorbed energy to modify the rotation direction of the output shaft, the power required to rotate the brush head in a particular pattern may be reduced. In some instances, the dowel pin may extend through the output shaft to contact a first bumper and a second bumper. In these instances, the opposing ends of the dowel pin may contact the rubber bumpers substantially simultaneously and in opposite directions (due to the rotation of the shaft and subsequent movement of the bumpers therewith). The force experienced by the ends of the dowel pin may provide torque to the shaft, which further acts to conserve energy. The torque provided may be a pure reversal torque in that the net force reaction on the output shaft may be freed of any side loads that could result in additional audible noise and wear on the bearings and other linkage components, as well as waste energy. In addition to conserving energy, the bumpers and dowel pin may further reduce wear and tear on the output shaft and other components of the linkage between the drive shaft and the output shaft, by reducing movement and friction.

In some instances, one or more components of the drive assembly may be formed through a plastic injection molding process. For example, a chassis and/or chassis cover may be formed from plastic components, rather than metal components. The plastic components may be strengthened with support ribs or the like, to provide additional rigidity to the plastic material. By using materials such as plastics that can be injection molded, some machining processes (such as drilling, tapping, and/or milling) may be omitted. As an example, rather than tapping treads in metal, the fasteners for the chassis and chassis cover may be off the shelf screws or nuts.

### Overview of the Toothbrush

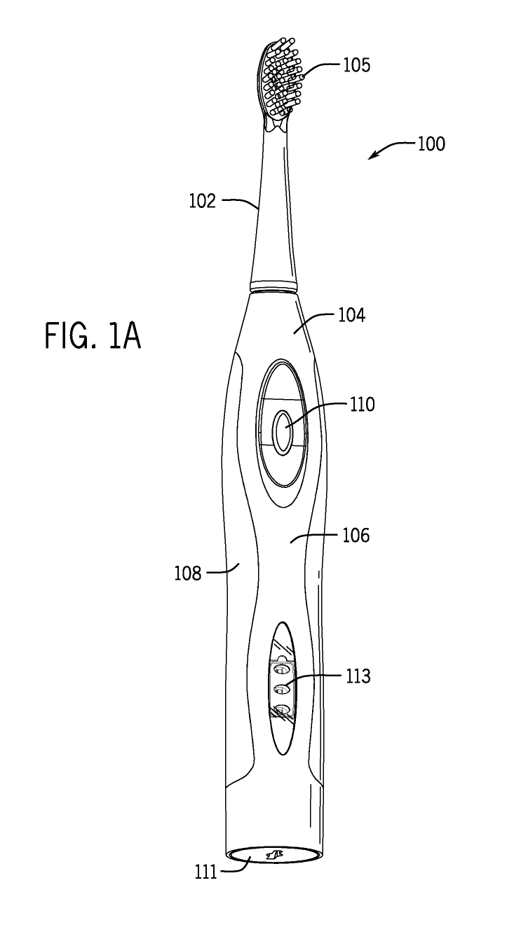

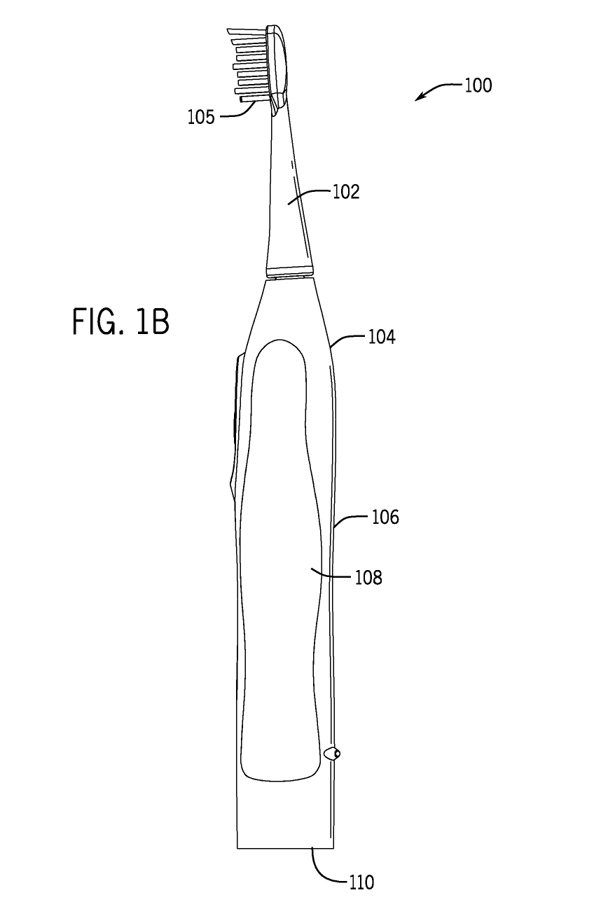

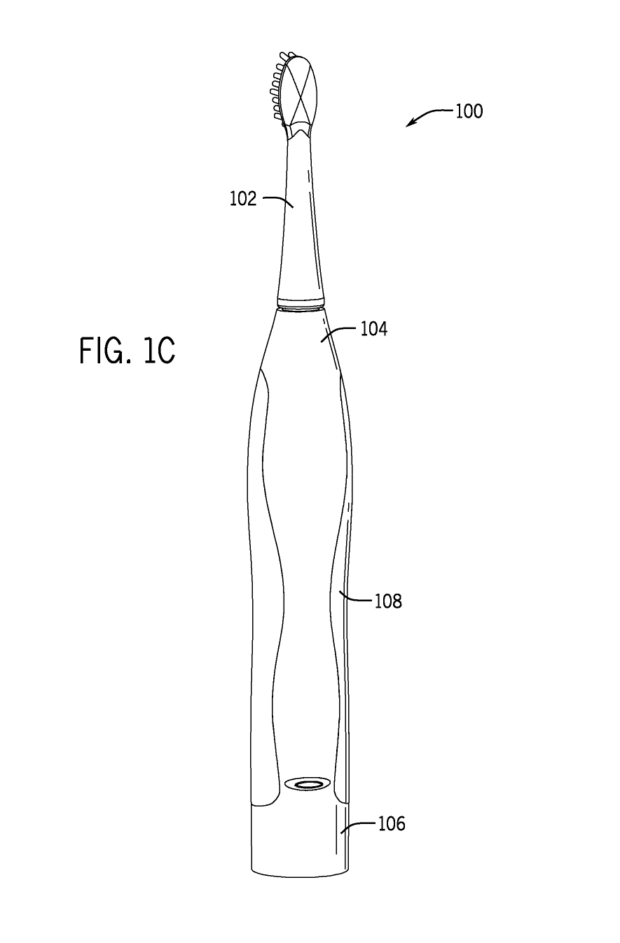

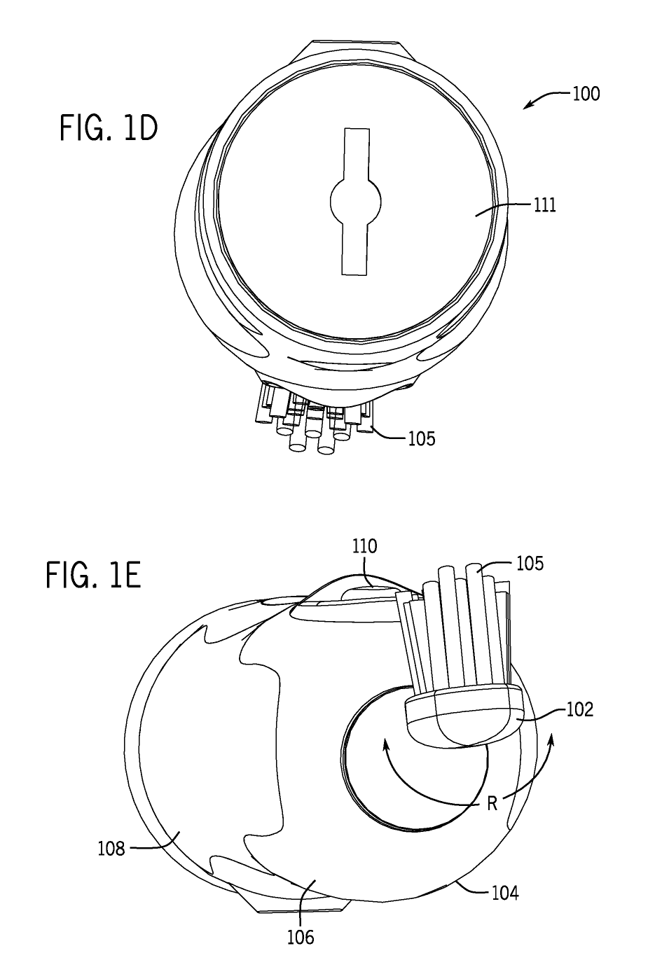

Turning now to the figures, the toothbrush will now be discussed in more detail. FIGS. 1A-1E illustrate various views of the toothbrush. With reference to FIGS. 1A-1E, the toothbrush 100 may include a body 104 having a housing 106 and a hand grip 108 and a brush head 102 including a plurality of bristles 105 attached to the body 104. The brush head 102 may be removable from the body 104, which allows the brush head 102 to be replaced as the bristles 105 become worn or to allow different users to use the toothbrush 100.

The body 104 may be held by a user in his or her hand. The body 104 may have an elongated cylindrical shape that may have an upper portion that tapers towards the brush head 104. The toothbrush may include a hand grip 108 that provides a gripping surface for a user's hand and may be a softer material than the housing 106. The body 104 may include a control button 110 to activate the toothbrush 100, as well as to control one or more settings or speeds of the toothbrush 100. Additionally, an indication panel, which may include a plurality of lights or other display elements, may be viewable through the housing 106 of the body 104.

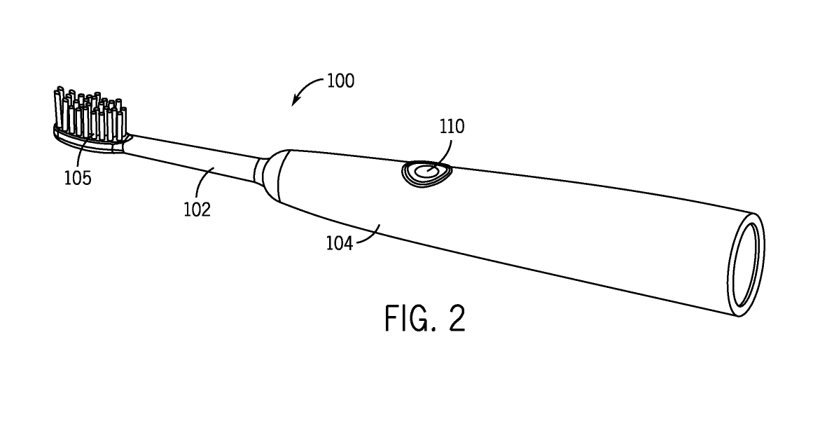

FIG. 2 is an isometric view of another example of a toothbrush in accordance with the present disclosure. With reference to FIG. 2, in this example, the toothbrush 100 may have a more simply shaped body without the hand grips and other features. However, the internal components may be substantially the same as the toothbrush shown in FIGS. 1A-1E.

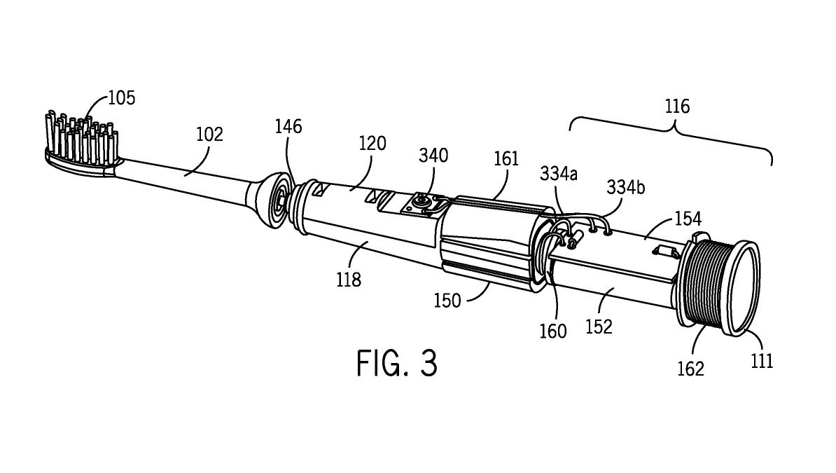

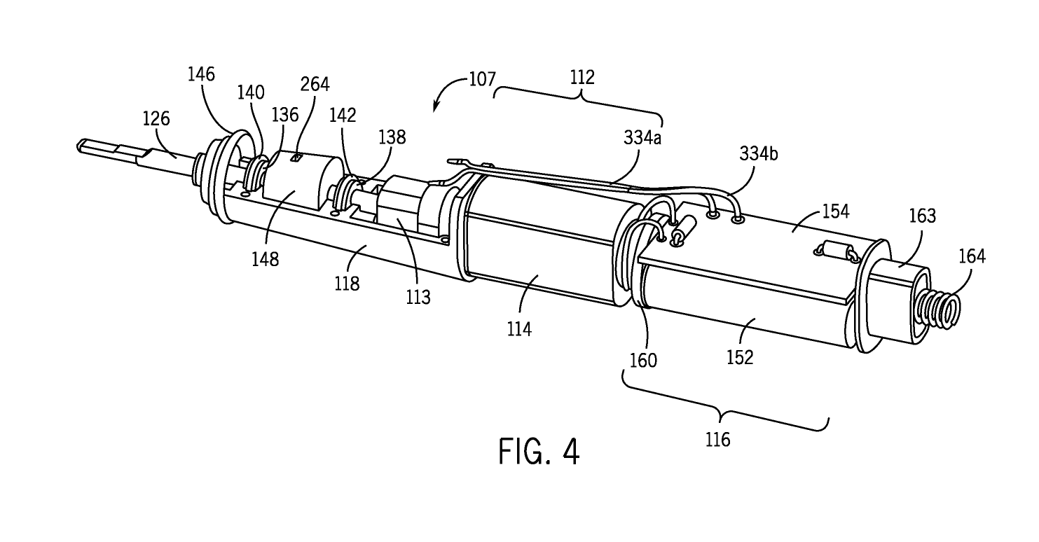

The body 104 houses the internal components of the toothbrush 100. FIG. 3 is an isometric view of the toothbrush 100 with the housing 106 removed for clarity. FIG. 4 is an isometric view of the toothbrush 100 with the housing 106 and a chassis cover removed for clarity. With reference to FIGS. 3 and 4, the toothbrush 100 may include a power assembly 116 and a drive assembly 112. The drive assembly mays include a linkage assembly 107 connecting the drive assembly 112 to the brush head 102. The power assembly 116 provides power to the drive assembly 112 which, through the linkage assembly 107, oscillates an output shaft 126 to move the brush head 102. Accordingly, the drive assembly 112 may be generally positioned above and electrically connected to the power assembly 116, with the linkage assembly 107 connecting the drive assembly 112 to the brush head 102. Each of these components will be discussed, in turn, below.

### Drive Assembly

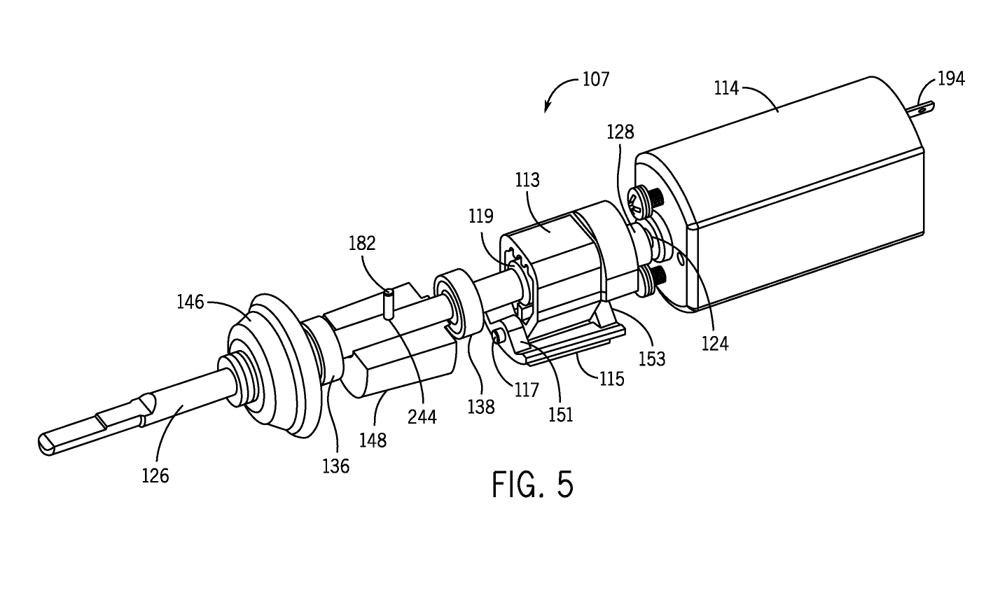

The drive assembly 112 will now be discussed in further detail. FIG. 5 is an enlarged isometric view of the toothbrush with select components removed for clarity. With reference to FIGS. 3-5, the drive assembly may include a motor 114, a linkage assembly 107, and output shaft 126. The linkage assembly 107 transfers movement from the motor 114 to the output shaft 126 and transforms the rotational movement of the motor 114 to an oscillating motion.

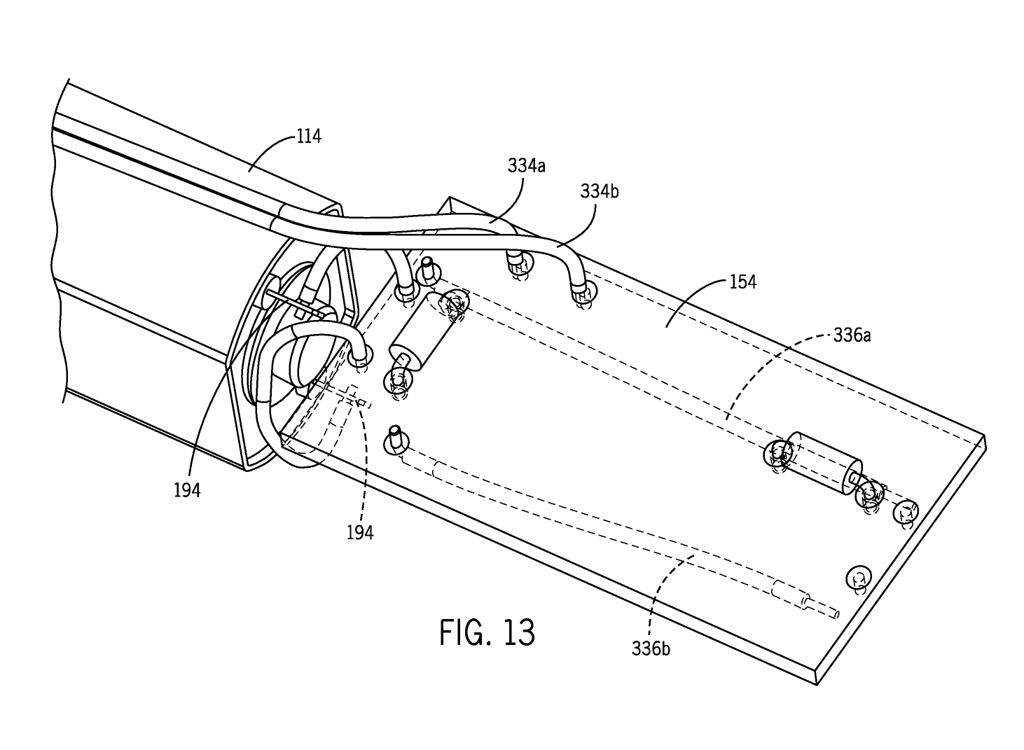

The motor 114 translates energy or power into movement. The motor 114 includes a drive shaft 124 extending from a top surface of the motor 114. The drive shaft 124 is rotated by the motor 114 in response to current provided by a voltage source. The motor 114 may include a set of terminals 194 or prongs. (Only one prong is shown in FIG. 5, but the other prong is substantially the same as the prong shown. See FIG. 13.). The two prongs 194 extend from a bottom end of the motor 114 and provide an electrical connection between the motor 114 and the power assembly 116. The motor 114 may be a constant speed motor or may be a variable speed motor. Additionally, the motor 114 may be a direct current motor or an alternating current motor.

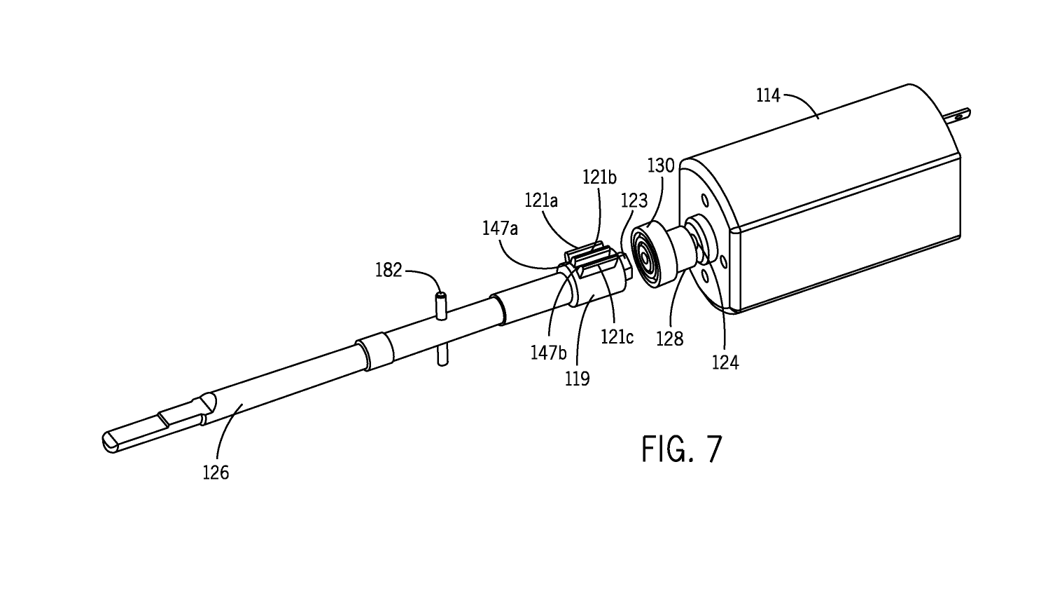

An eccentric 128 is connected to the drive shaft 124 of the motor 114. FIG. 7 is an isometric view of the toothbrush with select components removed for clarity. With reference to FIGS. 5-7, the eccentric 128 includes a body structure that defines an asymmetrically distributed weight, which changes rotation characteristics of the eccentric 128. Further, the eccentric 128 may include a variation in distribution of mass on either side of a shaft aperture 200 that function as a counterweight to balance the weight of a linkage ball bearing 130, discussed in more detail below.

With reference to FIGS. 4-7, the components of the linkage assembly 107 will be discussed in more detail. The linkage assembly 107 may include a cam follower 113, a linkage ball bearing 130, a planet gear 119, and a clevis 115. The linkage ball bearing 130 and the eccentric 128 connect the other components of the linkage assembly 107 to the drive shaft 124 of the motor 114, as will be discussed in more detail below.

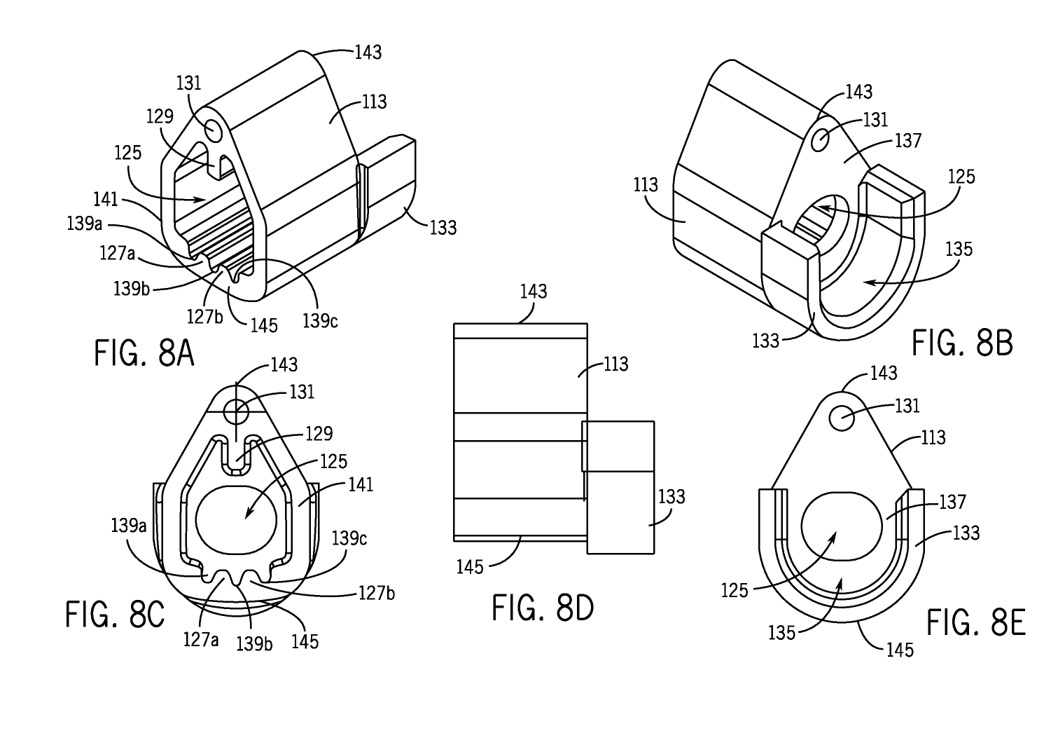

The cam follower 113 connects the linkage ball bearing 130 and eccentric 128 to the other components of the linkage assembly 107 and assists in transferring motion of the drive shaft 124 to the output shaft 126. FIGS. 8A-8E illustrate various views of the cam follower 113. With reference to FIGS. 8A-8E, the cam follower 113 includes a somewhat triangularly shaped body with a gear aperture 125 extending longitudinally therethrough. The gear aperture 125 has a first cross-section area defined within the top surface 141 of the cam follower 113 and a smaller second cross-section area defined on the bottom surface 137 of the cam follower 113 that is oblong or racetrack-shaped with major and minor diameters. Thus, the bottom surface 137 of the cam follower 113 reduces the size of the diameter of the gear aperture 125 at the bottom end of the cam follower 113.

A pivot aperture 131 is defined parallel to the extension of the gear aperture 125 but separated from the gear aperture 125 by a wall. The pivot aperture 131 has a smaller diameter than the gear aperture 125 and is formed at a first end 143 of the cam follower 113 defining the smallest width of the cam follower 113 body, i.e., at the tip of the triangular cross-section. A rib 129 extends into the gear aperture 125 from an interior wall of the cam follower 113. The rib 129 extends longitudinally along a length of the gear aperture 125 and provides additional support strength for the cam follower 113 and helps to maintain the position of the planet gear 119 within the cam follower 113.

With reference to FIGS. 8A and 8C, the cam follower 113 includes a plurality of follower gear teeth 127a, 127b extending into the gear aperture 125 from an interior sidewall. The gear teeth 127a, 127b may be positioned on an opposite sidewall from the rib 129. A plurality of gear grooves 139a, 139b, 139c are defined adjacent and positioned between the gear teeth 127a, 127b. The gear teeth 127a, 127b and gear grooves 139a, 139b, 139c define a partial ring gear structure that meshes with corresponding teeth on the planet gear 119, discussed in more detail below.

With reference to FIGS. 8A-8E, the cam follower 113 includes a bearing wall 133 extending outwards from the bottom surface 137 of the cam follower 113. The bearing wall 133 is a U-shaped wall partially surrounding the bottom end of the gear aperture 125. The bearing wall 133 defines a bearing compartment 135 and is configured to receive the eccentric 128 and linkage ball bearing 130, discussed in more detail below. The bearing wall 133 may be partially offset from the second end 145 of the cam follower 113 so that a portion of the bearing wall 133 extends below a terminal end of the second end 145. (See FIG. 8D.)

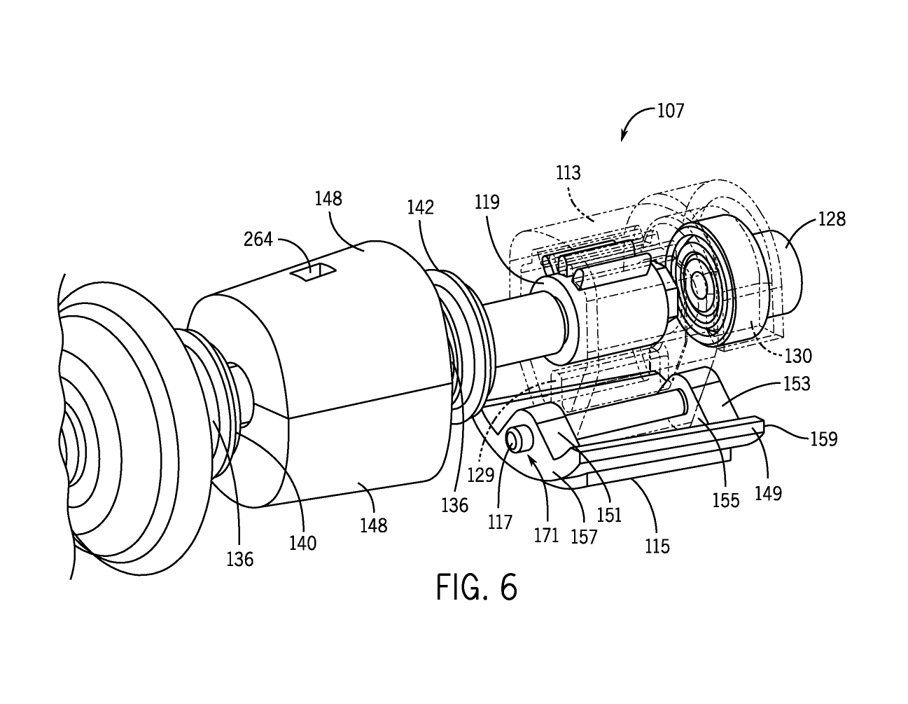

With reference to FIG. 6, the clevis 115 of the linkage assembly 107 connects to the cam follower 113. The clevis 115 includes two lobes 151, 153 extending upwards from a top surface of the clevis 115 and a first end 157 and a second end 159, respectively, of the clevis 115. Each of the lobes 151, 153 include a pin aperture 171 defined therethrough and configured to receive a pin 117. A top surface 155 of the clevis 115 defines a concave well that provides clearance for the cam follower 113 to pivot on the pin 117, as discussed in more detail below.

With reference again to FIG. 7, the planet gear 119 of the linkage assembly 107 will be discussed in more detail. The planet gear 119 functions to transfer motion from the cam follower 113 to the output shaft 126. The planet gear 119 may have a generally cylindrically shaped body with a plurality of planet gear teeth 121a, 121b, 121c extending outwards from and longitudinally along an outer surface of the body. The gear teeth 121a, 121b, 121c extend at an angle outwards to define angled slots 147a, 147b between each of the teeth.

With reference to FIGS. 3-5, the output shaft 126 extends from the linkage assembly 107 to connect to the brush head 102. In some examples, the output shaft 126 may be formed as a single-component. However, in other embodiments, the output shaft 126 may be connected to a separate tip shaft that then connects to the brush head 102. The output shaft 126 may include one or more keying features, such as cutouts, depressions, or the like, that keys the output shaft to the brush head 102 and/or components of the linkage assembly 107.

As shown in FIG. 5, a dowel aperture 244 may be defined through a width of the output shaft 126. Additionally, the output shaft 126 may include one or more bearing sleeves (not shown) that include portions of additional material extending from the outer surface of the output shaft 126.

With reference to FIGS. 4 and 5, two or more ball bearings 136, 138 may be connected to the output shaft 126. The ball bearings 136, 138 may be spaced apart from one another and each includes two races enclosing a plurality of balls, where the balls are configured to travel around and rotate around the races.

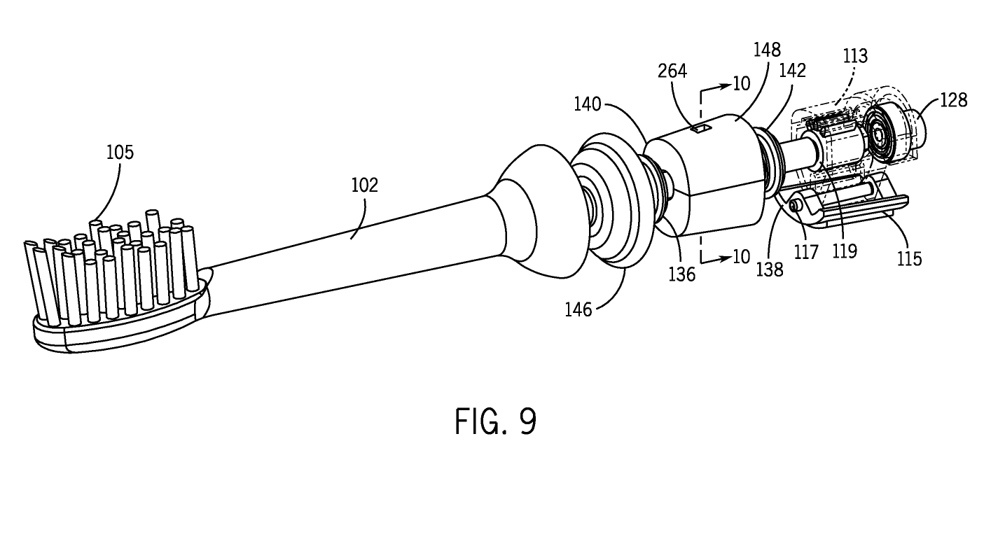

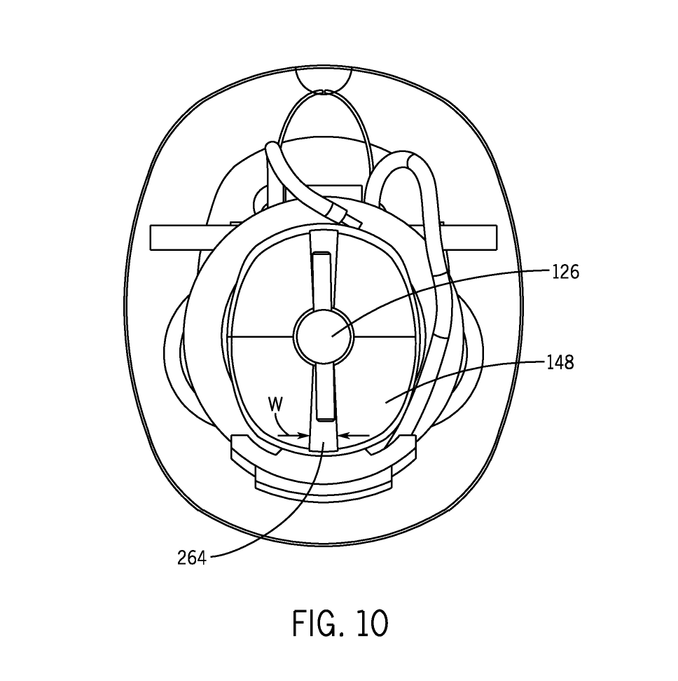

In some embodiments, the toothbrush 100 may include one or more bumpers 148 connected to the output shaft 126. FIG. 9 is an isometric view of the toothbrush with select components removed for clarity. FIG. 10 is a cross-section view of the toothbrush taken along line 10-10 in FIG. 9. With reference to FIGS. 4, 6, 9, and 10, each bumper 148 may include an interior curved wall configured to wrap around a portion of the output shaft 126. Each bumper 148 may include a pin aperture 264 defined through a sidewall thereof. The pin aperture 264 may have a relatively rectangular shape but may otherwise be configured to receive an end of the dowel pin 182 discussed in more detail below. With reference to FIG. 10, the width of the pin aperture 264 may vary along a width of the sidewall of the bumper 148. For example, the width W of the pin aperture 264 may increase from the interior wall of the bumper 148 towards the outer wall.

The toothbrush 100 may include two bumpers 148, with each of the bumpers 148 being substantially the same. In implementations where the bumpers 148 may be substantially the same, the tooling costs for the toothbrush may be reduced, as both bumpers may be created in the same equipment. However, in other embodiments, the bumpers may be different from one another or the bumper 148 assembly may be a single bumper having a receiving aperture defined therethrough.

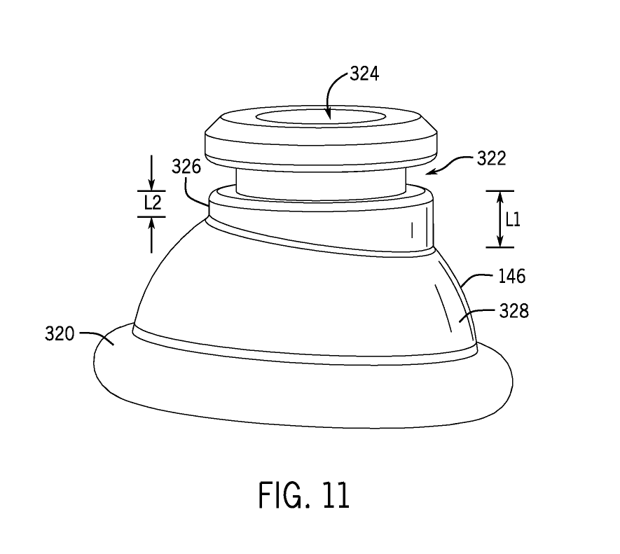

The toothbrush 100 may also include a sealing member positioned at a location beneath the brush head 102. FIG. 11 is a front isometric view of a boot seal. With reference to FIGS. 5, 9, and 11, the boot seal 146 is a sealing member that may be formed of a deformable material. In some embodiments, the boot seal 146 may include a skirt 328 that extends outwards and downwards to define a boot cavity 330. A terminal edge of the skirt 328 may define a lip 320. The lip 320 may include rounded edges, similar to an O-ring.

With reference to FIG. 11, a seat post 326 may extend from a top portion of the skirt 328 and an annular groove 322 may be defined within the seat post 326. The skirt 328 may be defined at an angle such that a length between the annular groove 322 and the top surface of the skirt 328 on a first side of the boot seal may vary from a second side. For example, with reference to FIG. 11, a first side of the seat post 326 beneath the annular groove 322 may have a first length L1 and a second side of the seat post 326 beneath the annular groove 322 may have a length L2, where the first length L1 is longer than the second length L2. The portion of the skirt 328 below L2 may also be wider than the portion of the skirt 328 below L1. This difference in length may be determined based on a desired angle between the brush head 102 and the body 104. In other words, the brush head 102 may be orientated at an angle relative to the body 104 and the difference in lengths L1 and L2 may be based on the degree of angulation. In some embodiments, the body 104 may also be somewhat angled to accommodate the angle of the brush head 102 and in these embodiments, the varying lengths L1 and L2 of the boot seal 146 may help to ensure a seal between the housing 106 and the seal boot 146. It should be noted that in other embodiments, the motor and drive assembly may not tilted and the boot seal 146 may be generally symmetrically shaped.

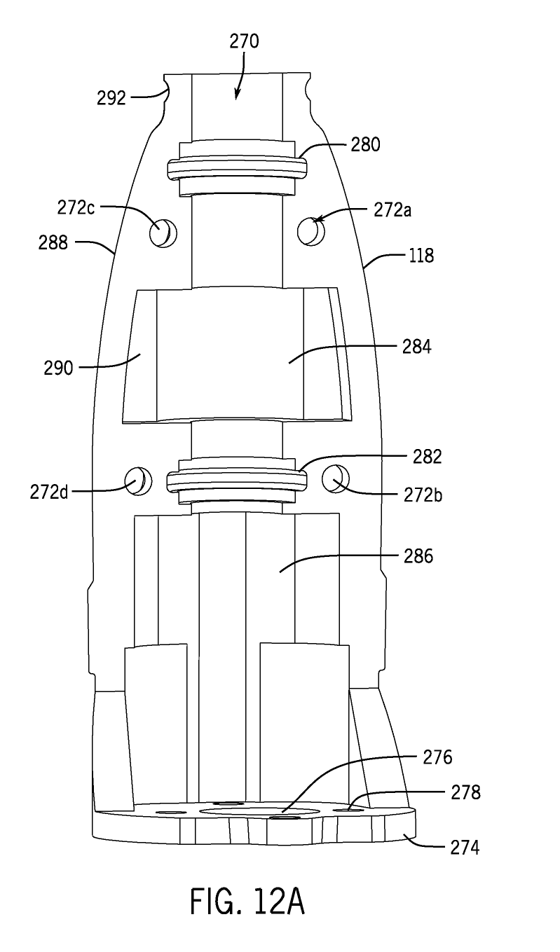

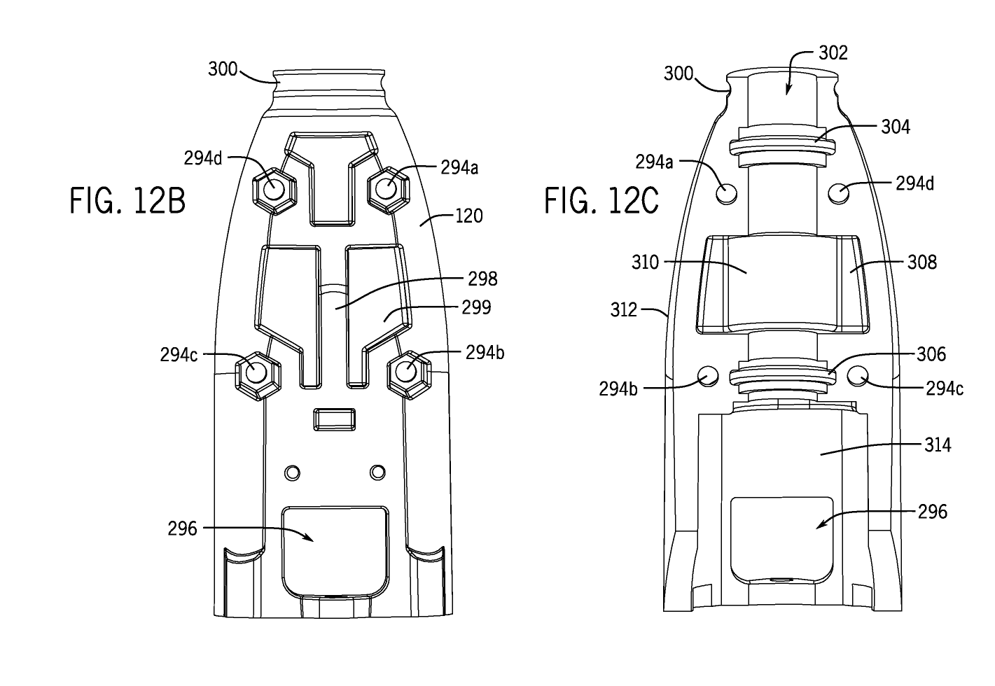

The drive assembly 112 may further include a chassis 118 to support the various components within the body 104 of the toothbrush 100. FIG. 12A is a front elevation view of the chassis. With reference to FIGS. 4 and 12, the chassis 118 may include a base 274 to support the chassis 118, as well as a plurality of cavities to receive the components of the drive assembly 112 and linkage assembly 107. Additionally, the chassis 118 may include a plurality of fastening apertures 272a, 272b, 272c, 272d defined through a sidewall and a plurality of fastening apertures 278 defined through the base 274 to receive one or more fastening members. A groove 292 may be defined around a top end of the chassis 118.

The cavities defined within the chassis 118 may generally conform to the components of the drive assembly 112. For example, a shaft cavity 270 may be formed along a length of the chassis 118 and may generally correspond to the output shaft 126. Two bearing cavities 280, 282 may be defined along a length of the shaft cavity 270. The bearing cavities 280, 282 may have a larger diameter than the shaft cavity 270. A bumper cavity 284 may be defined between the two bearing cavities 280, 282. The bumper cavity 284 may have a larger diameter than the bearing cavities 280, 282. Additionally, the bumper cavity 284 may have a cylindrical portion 388 and a flange portion 290, whereas the bearing cavities 280, 282 may be generally cylindrical.

A linkage cavity 286 may be defined beneath the second bearing cavity 282. The linkage cavity 286 may generally conform to the shape of the linkage assembly 107, and may allow movement of the cam follower 113. Thus, the linkage assembly 107 may be configured to define a spacing gap between movable components of the linkage assembly 107 and the walls of the cavity.

A chassis cover 120 may connect to the chassis 118 to enclose select components of the drive assembly 112. With reference to FIGS. 12B and 12C, the chassis cover 120 may include a plurality of fastening apertures 294a, 294b, 294c, 294d defined through a front face of the chassis cover 120. Additionally, the chassis cover 120 may define a cover aperture 296, which may be defined on a bottom portion of the chassis cover 120. In some embodiments, the cover aperture 296 may be omitted and the linkage assembly 107 may be enclosed within the chassis and chassis cover. The chassis cover 120 may further include a groove 300 extending around an outer surface of the top portion of the cover 120.

The outer surface of the chassis cover 120 may include a plurality of ribs 298 or other strengthening members. The ribs 298 may be defined by rib recesses 299 on adjacent sides of the ribs 298. The ribs 298 provide rigidity to the chassis cover 120. The additional rigidity provided by the ribs 298 may allow the chassis cover 120 and chassis 118 to be formed out of less rigid materials. For example, in some embodiments, the chassis cover 120 may be formed out of plastic, e.g., through plastic injection molding, which may reduce costs as compared to a machine die casting component, while still providing sufficient rigidity.

With reference to FIG. 12C, similar to the chassis 118, the chassis cover 120 may define a plurality of cavities that may receive various components of the drive assembly 112. The chassis cover 120 may define a shaft cavity 302, two bearing cavities 304, 306, a bumper cavity 308, and a linkage cavity 314. The cavities may be substantially similar to the cavities defined in the chassis 118 and may generally conform to one or more components of the drive assembly 112.

The bearing cavities 304, 306 may be substantially cylindrically shaped and may have a larger diameter than the shaft cavity 302. The bumper cavity 308 may be positioned between the two bearing cavities 304, 306 and may include a cylindrical portion 310 and a flange portion 312 extending from the cylindrical portion 301 and have a depth that may be less than a depth of the cylindrical portion 310. The linkage cavity 314 may be defined beneath the second bearing cavity 306 and may generally enclose the movable components of the drive assembly 112. Accordingly, as with the linkage cavity 286 in the chassis 118, when assembled, the linkage cavity 314 may define a spacing gap or distance between the moveable components and the walls of the chassis cover 120.

### Power Assembly

The power assembly 116 will now be discussed in more detail. FIG. 13 is a top isometric view of the connection between the motor 114 and the control circuit 154. With reference to FIGS. 3, 4, and 13, the power assembly 116 may include one or more batteries 152, a control circuit 154, and a charging coil 162. The power assembly 116 provides power to the motor 114 to drive the drive shaft 124, as will be discussed in more detail below. Additionally, the power assembly 116 may include one or more isolation or dampening members 150, 160 that may connect one or more components of the power assembly to the housing and the motor 114.

The one or more batteries 152 may be rechargeable or may be single use. Additionally, the number, size, type, and capacity of the batteries 152 may be varied as desired. In embodiments where the batteries 152 may be rechargeable, the toothbrush 100 may further include the charging coil 162. The charging coil 162 may be a copper wire wrapped around itself or otherwise configured to receive an induced current flow remotely from a power source. For example, the toothbrush 100 may include a charger (not shown) that couples to the charging coil 162 to remotely induce a current in the charging coil 162 that may be used to provide power to the battery 152. Accordingly, the charging coil 162 may be in electrical communication with the battery 152.

The battery 152 and the charging coil 162 may be in electrical communication with a control circuit 154. For example, one or more wires 336a, 336b may transmit current from the battery 152 and charge coil 162 to the control circuit 154. The control circuit 154 may include one or more electrical components, such as a control chip, resistors, capacitors, or the like. In some embodiments, the control circuitry 154 may be a printed circuit board or other substrate that provides support for one or more electrical components and allows communication between those components.

The control circuitry 154 selectively provides power from the battery 152 to the motor 114, and further may vary one or more functions of the toothbrush 100. The control circuit 154 may also be in communication with a button circuit 340. (see FIG. 3.) The button circuitry 340 may receive user inputs from the button 110 and provide those inputs to the control circuit 154. In some embodiments, two or more communication wires 334a, 334b may transmit signals from the button circuit 340 to the control circuit 154.

The power assembly 116 may also include one or more soft mounts or dampeners. The dampeners may reduce vibrations created by the drive assembly 112 from being transmitted to the housing 106 of the body 104. With reference to FIG. 3, the toothbrush may include a first isolator 150 positioned about the motor 114 and a second isolator 160 positioned on a top end of the power assembly 116. The isolators 150, 160 may include a number of securing or keying features that may connect the isolators 150, 160 to various components of the toothbrush 100. The isolators 150, 160 may be formed from a compressible or deformable material that may absorb vibration and sound waves. For example, the isolators 150, 160 may be silicon or other elastomeric materials.

The first isolator 150 may be shaped as a sleeve or other hollow member. The first isolator 150 may include one or more wire channels 161 defined along its outer surface and extending longitudinally along a length of the isolator 150. The wire channels 161 may have a width that corresponds to one or more of the communication wires 334a, 334b and my define a portion of the pathway for the communication wires 334a, 334b as they extend from the control circuit 154 to the button circuit 340.

The toothbrush 100 may also include a biasing member to exert a compression force against the internal components of the toothbrush 100. With reference to FIG. 4, the toothbrush 100 may include a compression spring 164 that acts to compress the various components of the toothbrush 100 together. The compression spring 164 may be a coil spring or other resilient member. With reference to FIG. 4, a third isolator 163 positioned at a bottom end of the power assembly 116 may be somewhat oval in shape and have an interior cavity configured to receive the compression spring 164 as well as a flange on the top surface that is configured to engage with a bottom end of the batteries.

A bottom cap 111 may be connected to the bottom of the housing 106. The bottom cap 111 may be connected to the toothbrush housing 106 by any of several different mechanisms, such as, but not limited to, twist lock, snap fit, fasteners, and so on.

### Assembly of the Toothbrush

The various components of the toothbrush 100 may be interconnected together and received into the housing 106 and brush head 102. With reference to FIGS. 2-4, starting from the bottom up, the compression spring 164 is received into the cavity of the third isolator 163 and the charging coil 162 is positioned around the outer surface of the third isolator 183. The charging coil 162 abuts against a bottom surface of the flange of the third isolator 183. Once the spring 164 and coil 162 are connected to the third isolator 163 the bottom cap 111 is connected to the third isolator 163. The bottom cap 111, when connected, biases the compression spring 164 upwards against the third isolator 163. In this manner, the compression spring 164 may be at least somewhat compressed and exert a force against the batteries 152, which may compress the various components of the toothbrush 100 towards one another. The bottom cap 111 may be locked into position inside the housing 106 through one or more interlocking features (not shown).

The batteries 152 are positioned on top of the third isolator 163 and are electrically connected with the charge coil 162. The control circuit 154 is arranged to extend longitudinally along a side of the batteries 152. The batteries 152 abut against a bottom end of the second isolator 160. The motor 114 is positioned on top of the second isolator 160 and the connection terminals 194 extend on opposite sides of the second isolator 160. The terminals 184 of the motor 114 are then electrically connected to the control circuit 154 and placed in selective communication with the batteries 152.

With continued reference to FIGS. 2-4, the first isolator 150 may be received around the motor 114, with the terminals 194 of the motor 114 extending beyond the bottom edge of the outer wall of the isolator 150. When the housing 106 is connected to the toothbrush, the isolator 150 may also be engaged with the interior surface of the housing 106. The engagement with the housing 106 and encasement of the motor by the isolator 150 assists in preventing vibrations from the motor 114 from being transferred into the power assembly 116 and/or handle. For example, the material of the isolator 150 may absorb the vibrations, preventing or reducing them from being transmitted.

The compression spring 164, along with the isolator 150 may reduce slop between the drive assembly and power assembly, by compressing the internal components together. The reduction in slop may reduce vibration due to components rattling or moving during operation, as well as may reduce wear and tear on the drive assembly and power assembly. For example, the compression spring 164 force may reduce the degrees of movement significantly, which helps to retain the limited movement of the chassis assembly, acting to isolate the chassis assembly from the housing, as well as reduce the likelihood that the chassis assembly will excite vibration in the power assembly.

With reference to FIG. 13, one or more connection wires 336a, 336b connect the circuit 154 to the charge coil 162 to transmit power from the charge coil 162 to the control circuit 154 and then to the battery 152. The connection wires 336a, 336b may connect to a bottom end of the circuit 154 and, with reference to FIGS. 4 and 13, the power wires 336a, 336b may extend upwards along the battery 152, connect to the motor terminals 194, and transmit current to the motor. In this manner, the power wires 336a, 336b communicatively couple the control circuit 154 to the motor 114.

The base 274 of the chassis 118 is positioned on the top end of the isolator 150 and the drive shaft 124 may extend into the chassis 118. With reference to FIGS. 5-7 the eccentric 128 is threaded onto the drive shaft 124, with the drive shaft 124 being inserted into a shaft aperture in the eccentric 128. The linkage ball bearing 130 is then received around the eccentric 128. As described above, the eccentric 128 may include more material on one side of its body so that the eccentric 128 may have more mass on one side of its centerline as compared to the other side.

As briefly discussed above the asymmetrical distribution in weight of the eccentric 128 defines a counterweight for the linkage ball bearing 130 and balances the ball bearing 130 on the eccentric 128. In the exemplary embodiment shown, the counterweight of the eccentric 128 is integrally formed therewith. However, in other embodiments an external counterweight may be received onto the eccentric 128. The counterweight of the eccentric 128 balances the ball bearing 130, reducing noise as the eccentric is rotated by the drive shaft, discussed in more detail below.

With reference to FIGS. 6 and 8A-8E, the cam follower 113 is connected to the eccentric 128 and the linkage ball bearing 130. In particular, the linkage ball bearing 130 and the eccentric 128 are positioned in the bearing compartment 135 and are at least partially surrounded by the bearing wall 135.

With reference to FIGS. 7 and 8A-8E, the output shaft 126 is connected to the planet gear 119. The planet gear 119 is received around a terminal end of the output shaft 126 and a hexagonal nut 123 is threaded onto the end of the output shaft 126 to secure the planet gear 119 in position. The planet gear 119 and the nut 123 are then positioned into the gear aperture 125 of the cam follower 113. The nut 123 is positioned adjacent the back wall of the gear aperture 125, i.e., the interior side of the bottom surface 137 the cam follower 113. The planet gear 119 is aligned within the gear aperture 125 so that the gear teeth 121a, 121b, 121c are received into the gear grooves 139a, 139b, 139c of the cam follower 113.

With reference to FIG. 6, the clevis 115 is connected to the cam follower 113. The cam follower 113 is positioned between the two lobes 151, 153 of the first and second ends 157, 159 of the clevis 115. The pivot pin 117 is then inserted through the aperture in a first of the two lobes 151, 153, through the pivot aperture 131 of the cam follower 113, and then through the second of the two lobes 151, 153. The pivot pin 117 extends through the sidewalls of the lobes 151, 153 and through the length of the pivot aperture 131. The pivot pin 117 may extend past the edge of the outer surface of each of the lobs 151, 153 to secure the cam follower 113 between the two lobes 151, 153.

With reference now to FIGS. 4 and 5, the output shaft 126 may extend upwards from the cam follower 113. The first ball bearing may be received around the output shaft 126 at a first position above the dowel pin 182 and the second ball bearing 138 may be received around the output shaft 126 at a second position before the dowel pin 182. Additionally, each ball bearing 136, 138 may include a sealing member received around an outer portion thereof. For example, a first O-ring 140 may be received circumferentially around the first ball bearing 136 and a second O-ring 142 may be received circumferentially around the second ball bearing 138.

The O-rings 140, 142 received around the ball bearings 136, 138 may reduce rattling in instances where the chassis 118 and chassis cover 120 are loose or have extra space between the ball bearings 136, 138. When the fit of the chassis 118 and chassis cover 120 around the outer diameter of the ball bearings 136, 138 may be loose, the O-rings 140, 142 may extend into the extra space, tightening the connection between the chassis 118 and the ball bearings 136, 138. Additionally, the O-rings 140, 142 may provide a uniform load around the bearings 136, 138, which helps to prevent the bearings 136, 138 from being forced into an asymmetrical shape (e.g., oblong) due to the rotation forces exerted by the output shaft 126. In other words, as the ball bearings 136, 138 rotate the O-rings 140, 142 may distribute the load uniformly.

By reducing rattling and providing a uniform load on each of the bearings 136, 138, the O-rings 140, 142 reduce audible noise that may be generated during operation of the toothbrush. Additionally, because the O-rings 140, 142 may deform against the chassis 118 and chassis cover 120, looser tolerances may be used to manufacture the chassis and chassis cover, which may decrease manufacturing costs. Moreover, the O-rings 140, 142, which may typically be formed of a deformable material, such as an elastomeric material, may provide a soft mount between the ball bearings 136, 138 and the chassis 118 and chassis cover 120. This soft mount may act as an isolator or dampening member and absorb vibrations of the output shaft 126.

With continued reference to FIGS. 4, 5, and 10, the dowel pin 182 is received through the dowel aperture 244 in the output shaft 126. The bumper assembly may then be placed around the output shaft 126. For example, both bumpers 148 may be received around the output shaft 126 with the dowel pin 182 received in the dowel aperture 264 in each of the bumpers 148. In some embodiments, the bumpers 148 may be connected together and completely surround the output shaft 126. The bumpers 148 may fit within the recesses 284, 310 of the chassis 118 and chassis cover 120 to surround the output shaft 126. The channel formed between the bumpers 148 through which the shaft 126 extends is larger in diameter than the output shaft 126, so the output shaft 126 can pivot freely within the channel. The dowel pin 182 may be sufficiently long to extend through at least a portion of the thickness of the bumpers 148. The walls surrounding and defining the dowel aperture 264 in the bumpers 148 may act to restrain lateral movement of the dowel pin 182. In some examples, the dowel pin 182 may be securely positioned within the output shaft 126 and in other examples, the dowel pin 182 may be removably positioned within the output shaft 126.

With reference to FIGS. 1A-2 and 12A-12C, the chassis 118 and chassis cover 120 may be received around a number of the linkage and drive components. The cam follower 113, clevis 115, and eccentric 128 may be received in the linkage cavity 286, 314 in the chassis 118 and chassis cover 120, respectively. In other words, the chassis 118 and chassis cover 120 may be connected together such that the two linkage cavities 286, 314 may form a single cavity. The linkage cavities 286, 314 may be configured to receive the components of the linkage assembly 107, while still allowing the components to move as desired within the cavities.

The output shaft 126 may be received into the shaft cavity 270, 302 and the ball bearings 136, 138 may be received in the bearing cavities 280, 282, 304, 306, respectively. The output shaft 126 may extend outwards from a top end of both the chassis 118 and chassis cover 120. Additionally, the bumpers 148 may be received in the respective bumper cavities 284, 308 with the curved wall 266 of the bumpers being positioned in the cylindrical portion 288, 310 of the bumper cavities 284, 308.

Once the linkage components are received in the respective cavities in the chassis 118, the chassis cover 120 may be positioned over the chassis 118 and fastened thereto. For example, the plurality of fastening apertures 272a, 272b, 272c, 272d on the chassis and the fastening apertures 294a, 294b, 294c, 294d may be aligned and fasteners may be received therein to connect the chassis and chassis cover together. Additionally, fasteners 190 may be received through fastening apertures 278 in the base 274 of the chassis 118 to connect the chassis 118 to the foundation plate 122.

With reference to FIGS. 3-6, the boot seal 146 may be received around the output shaft 126 and seat on top of the chassis 118 and the chassis cover 120. In one embodiment, the lip 320 of the boot seal 146 may be inserted into the grooves 292, 300 on the chassis 118 and chassis cover 120. A seal ring 170 may be received into the annular groove 322 defined in the boot seal 146 and compress the boot seal 146 around the output shaft 126 to seal the boot seal against the output shaft 126. For example, the seal ring 170 may be a somewhat rigid material, such as brass. The seal ring 170 may squeeze against the neck of the boot seal 146 to help seal the boot seal 146 against the shaft. Additionally, the skirt 328 and seal 326 of the boot seal 146 may also press against the housing 106 to seal against the interior surface 396 of the housing 106.

With reference to FIG. 3, the output shaft 126 may be inserted into the brush head 102 and secured together. In some instances the brush head 102 may be removable and/or replaceable and so the securing element may allow selective removal of the brush head 102.

With reference now to FIGS. 2 and 3, the button circuit 340 and the button 110 may be connected to the front side of the chassis cover 120 and may be positioned on the chassis cover 120 above the cover aperture 296. Connection wires 334a, 334b may extend from the control circuit 154 to the button circuit 340 and may electrically couple the control circuit 154 with the button circuit 340. In this manner as the button 110 is selectively activated by a user, the control circuit 154 may receive signals indicating the desired operation or setting selected by a user.

### Operation of the Toothbrush

The operation of the toothbrush 100 will now be discussed in more detail. With reference to FIGS. 1A-3, to activate the toothbrush 100, the user may press on the button 110. The button 110 may be pushed towards the button circuit 340, causing contacts on the button to connect with contacts on the button circuit 340. Once the button 110 has contacted the button circuit 340, the button circuit may transmit a signal through the communication wires 334a, 334b to the control circuit 154.

The control circuit 154 provides power to the motor 114 from the battery 152. For example, power from the battery 152 may be transmitted through the power wires 336a, 336b to the terminals 194 of the motor 114. As the motor 114 receives power, it begins to rotate the drive shaft 124. The eccentric 128 connected to the drive shaft 124 thus also begins to rotate.

With reference to FIG. 6, the inner wall of the linkage bearing 130 rotates with the eccentric 128 and the race of the ball bearing 130 is received within the bearing compartment 135 imparting motion to the cam follower 113. The linkage ball bearing 130 may reduce friction at the connection between the eccentric 128 and the cam follower 113, which reduces resistance, and results in reduced current consumption for the motor 114. Thus, the ball bearing 130 may help to reduce the load experienced by the by motor 114, which may increase the efficiency of the motor 114 and extend battery life. Additionally, the reduction in friction may reduce the audible noise produced at the joint.

With continued reference to FIGS. 6 and 9, the rotational movement of the eccentric 128 causes the cam follower 113 to pivot back and forth on the pivot pin 117 held in the clevis 115. The clearance provided by the well 155 of the clevis 115 allows the cam follower 113 to oscillate on the pivot pin 117 unobstructed by the clevis 115. The bearing wall 133 engages the linkage bearing 130 to move therewith. Because the pivot pin 117 is secured to the clevis 115, the cam follower 113 motion is limited to oscillating partial back and forth for the movement about the pivot pin 117, i.e., oscillation rather than full rotation For example, oscillation may include rotating a particular number of degrees in a first direction and then rotating a particular number of degrees in a second direction without rotating 360 degrees in any direction. The cam follower 113 may be configured to pivot about the centerline of the clevis 115. As the cam follower 113 oscillates, the motion of the cam follower 113 is imparted to the planet gear 119 by the engagement of the gear teeth 121a, 121b, 121c of the planet gear 119 with the gear grooves 139a, 139b, 139c of the cam follower 113. In this arrangement, the ring gear of the cam follower 113 may act as the outer annular gear to the planet gear 119, although the gear teeth 127a, 127b do not extend along a complete annular wall of the cam follower 113.

During movement, the planet gear 119 may rotate one or more additional degrees of rotation or oscillation for every degree of rotation or oscillation of the cam follower 113. This is due to the ratio of the gear teeth 127a, 127b of the planet gear 119 to the gear teeth 127a, 127b of the cam follower 113. In particular, to the cam follower 113 may be held at a constant distance from the output shaft 126 by virtue of its connection to the clevis 115 by the pivot pin 117. As the distance between the axis of the brush shaft 126 axis and the pivot pin 117 increases, the radius of the planet gear 119 decreases, decreasing the number of effective gear teeth of the planet gear 119 and causing the greater rotation ratio. In one example, the planet gear 119 may rotate three degrees for every one degree that the cam follower 113 oscillates, i.e., producing a 1:3 overdrive.

It should be noted that the above gear teeth are meant as examples and in other embodiments the relative radii and the number of gear teeth on the planet gear 119 and/or cam follower 113 may be varied to produce other ratio outputs. The gear ratio of the planet gear 119 to the cam follower 113 may be configured such that the output shaft 126 may oscillate faster than the cam follower 113 to provide sonic oscillation movement R for the brush head 102 (see FIG. 1E) at a lower motor speed 114 than may otherwise be required.

In some embodiments, the brush head 102 may move in a semicircular pathway, oscillating in the pathway shown by the rotation arc R. This causes the bristles 105 to move from side to side, which may be useful for the removal of debris and plaque from a user's teeth.

With reference to FIGS. 4 and 5, as the output shaft 126 pivots, the elastomeric bumpers 148 may act to conserve energy in the system. As described above, the dowel pin 182 is received through the output shaft 126 and extends from opposing sides of the output shaft 126 within symmetric opposing spaces between the two bumpers 148. As the output shaft 126 pivotably reciprocates, opposing ends of the dowel pin 182 contact opposite edges of respective bumpers 148. The contact between the dowel pin 182 and the bumpers 148 due to reciprocation of the output shaft 126 may occur simultaneously and in opposite directions. This impact imparts a torque on the shaft 126 in an opposite direction to the present pivot direction of the output shaft at the end of the travel in that direction of the cycle. The bumpers 148 (through the dowel pin 182) thereby act to conserve some of the kinetic energy of the output shaft and reapply the energy in the opposite direction. This energy conservation reduces stresses on the linkage assembly 107, thereby reducing wear and tear on the components, as well as audible noise generated during movement. Moreover, the load on the motor 114 may be reduced because the bumpers 148 conserve energy at one end of the rotation arc R and apply it to the shaft as it changes to head towards the other end of the rotation arc R.

As described above, the output shaft 126 is also connected to ball bearings 136, 138 and each of the ball bearings 136, 138 includes an O-ring 140, 142 surrounding and outer perimeter. As the output shaft 126 rotates, the O-rings provide a soft mounting to the chassis 118 and chassis cover 120 to further absorb vibrations due to the movement of the output shaft 126.

### CONCLUSION

The foregoing description has broad application. For example, while examples disclosed herein may focus on toothbrush, it should be appreciated that the concepts disclosed herein may equally apply to other types of motor powered devices where vibration isolation, increased rotation ratios, and noise reduction may be desired. Similarly, although the toothbrush is discussed with respect to a single speed motor, the devices and techniques disclosed herein are equally applicable to other types of drive mechanisms. Accordingly, the discussion of any embodiment is meant only to be exemplary and is not intended to suggest that the scope of the disclosure, including the claims, is limited to these examples.

The housing, chassis, chassis cover, and other elements of the various examples of the toothbrush assembly may be integrally formed or may be made of two or more separate components that are joined together by mechanical fasteners, sonic or heat welds, adhesives, chemical bonds, any other suitable method, or any combination thereof.

All directional references (e.g., upper, lower, upward, downward, left, right, leftward, rightward, top, bottom, above, below, vertical, horizontal, clockwise, and counterclockwise) are only used for identification purposes to aid the reader's understanding of the examples of the invention, and do not create limitations, particularly as to the position, orientation, or use of the invention unless specifically set forth in the claims. Joinder references (e.g., attached, coupled, connected, joined and the like) are to be construed broadly and may include intermediate members between the connection of elements and relative movement between elements. As such, joinder references do not necessarily infer that two elements are directly connected and in fixed relation to each other.

What is claimed is:

1. A toothbrush comprising
a brush head including a plurality of bristles;
a motor having a drive shaft;
a linkage assembly comprising a planetary gear arrangement connected to the drive shaft; and
an output shaft connected to the linkage assembly and the brush head; wherein
the linkage assembly converts a rotating movement of the drive shaft into an oscillating movement; and
the output shaft transmits the oscillating movement to the plurality of bristles.

2. The toothbrush of claim 1, wherein the planetary gear arrangement is arranged in an overdrive configuration.

3. The toothbrush of claim 2, wherein the overdrive configuration causes the output shaft to oscillate at a higher frequency as compared to a frequency produced by a direct connection of the output shaft to the drive shaft.

4. The toothbrush of claim 1, wherein the linkage assembly comprises
a cam follower connected to the drive shaft, the cam follower defining
a gear compartment; and
a plurality of follower gear teeth extending into the gear compartment; and
a planet gear connected to the output shaft comprising a plurality of planet gear teeth connected to a terminal end of the output shaft and received within the gear compartment;
wherein
a ratio of the follower gear teeth to the planet gear teeth determines an oscillation speed of the bristles.

5. The toothbrush of claim 4, wherein the planet gear oscillates at least two degrees for every one degree of oscillation of the cam follower.

6. The toothbrush of claim 4, wherein the linkage further comprises a clevis connected to the cam follower, the clevis comprises a first lobe extending upward from a first end and a second lobe extending upward from a second end, wherein the cam follower is positioned between the first lobe and the second lobe.

7. The toothbrush of claim 6, wherein
the cam follower comprises a pivot aperture defined along a length of the cam follower;
the first lobe and the second lobe of the clevis comprise a pin aperture defined therethrough; and
the toothbrush further comprises a pivot pin received through the pin aperture in the first lobe of the clevis, the pivot aperture of the cam follower, and the pin aperture in the second lobe of the clevis to connect the cam follower to the clevis.

8. The toothbrush of claim 7, wherein rotation of the drive shaft causes the cam follower to oscillate on the pivot pin.

9. The toothbrush of claim 8, wherein as the cam follower oscillates, the planet gear oscillates, and the planet gear has an increased number of degrees of oscillation as compared to the cam follower.

10. The toothbrush of claim 9, wherein the planet gear oscillates three degrees for every one degree of oscillation of the cam follower.

11. The toothbrush of claim 6, wherein the clevis comprises a concave well defined on a top surface, the concave well providing clearance for the cam follower to pivot on the pivot pin.

12. The toothbrush of claim 6, wherein the cam follower further comprises a rib extending parallel to the pivot aperture and the rib is located opposite of the follower gear teeth.

13. The toothbrush of claim 9, wherein the cam follower further comprises a bearing wall extending outward from a bottom surface of the cam follower.

14. The toothbrush of claim 13, wherein the bearing wall defines a bearing compartment for the cam follower.

15. The toothbrush of claim 14, further comprising an eccentric connected between the cam follower and the drive shaft of the motor.

16. The toothbrush of claim 15 further comprising a linkage ball bearing connected to the eccentric, wherein the linkage ball bearing and the eccentric are received in the bearing compartment of the cam follower.

17. The toothbrush of claim 1, further comprising an eccentric connected between the drive shaft and the linkage assembly.

18. An oral cleaning device comprising
an motor having a drive shaft;
a planetary gear linkage coupled to the drive shaft; and
a brush shaft connected to the planetary gear linkage; wherein
the planetary gear linkage oscillates the brush shaft in response to rotation of the drive shaft.

19. The oral cleaning device of claim 18, wherein the planetary gear linkage comprises
a ring gear connected to the drive shaft; and
a planet gear connected to the brush shaft; wherein
a gear ratio between the ring gear and the planet gear causes the brush shaft to rotate at least two degrees for every one degree of rotation in of the ring gear.

20. The oral cleaning device of claim 19, further comprising an eccentric connected between the drive shaft and the planetary gear linkage.
